(19) United States
(12) Patent Application Publication
(10) Pub. No.: US 2015/0076074 A1
(43) Pub. Date: Mar. 19, 2015

(54) SYNERGISTIC SILICA SCALE CONTROL

(71) Applicants: Dow Global Technologies LLC, Midland, MI (US); Rohm and Haas Company, Philadelphia, PA (US)

(72) Inventors: Somil Mehta, Mumbai (IN); Barry L. Turini, Kingwood, TX (US)

(21) Appl. No.: 14/386,925

(22) PCT Filed: Mar. 28, 2013
(86) PCT No.: PCT/US2013/034213

§ 371 Date: Sep. 22, 2014

Related U.S. Application Data
(60) Provisional application No. 61/618,117, filed on Mar. 30, 2012.

(51) Int. Cl. C02F 5/14; C02F 5/10

(52) U.S. Cl. CPC C02F 5/14; C02F 5/10; C02F 2305/00
USPC 210/701; 210/698

(57) ABSTRACT

A method for controlling colloidal/amorphous silica scale deposition in an aqueous system is described, which comprises adding to the aqueous system an effective amount of a synergistic combination comprising: A) 10% to 90% by weight of at least one carboxylate polymer comprising units derived from one or more carboxylate monomers; and B) 90% to 10% by weight of at least one chelating agent, based on the total weight of said synergistic combination. The carboxylate polymer may be a homopolymer of (meth)acrylic acid, maleic acid, itaconic acid, or their salts, or a copolymer of one or more monomers selected from meth)acrylic acid, maleic acid, itaconic acid, and their salts and, optionally, one or more sulfonic-free ethylenically unsaturated monomers. The chelating agent may be one or more of: methylamine, ethanolamine methylethanolamine (MEA), ethylenediamine (EDA), diethylenetriamine (DETA), ethylenediamine tetraacetic acid (EDTA), ethylenediamine disuccinic acid (EDDS), iminodiaacetic acid (IDA), tetrasodium ethylene diaminetetraacetic acid, and derivatives thereof, among others.

### FIELD OF THE INVENTION

The present invention relates to a method for controlling the deposition of amorphous silica scale in an aqueous system having neutral pH. This method comprises adding an effective amount of a synergistic combination of at least one carboxylate polymer and at least one chelating agent.

### BACKGROUND OF THE INVENTION

The deposition and accumulation of silica scale on internal surfaces of water treatment equipment, such as boilers, cooling, and purification systems which contain aqueous systems, is problematic because it reduces heat transfer and fluid flow through such equipment. Thus, prevention of formation and deposition of silica scale, as well as removal when such scale is deposited and accumulates, are of great interest to industries involving water treatment.

Formation of silica scale in aqueous systems is effected by various characteristics of the aqueous system, such as pH, temperature, the concentration of metal ions, etc. These characteristics may, themselves, vary widely from system to system according to the particular operating environment (e.g., cooling towers, boilers, reverse osmosis, geothermal, etc.). Such characteristics, especially pH and temperature, also determine which of the two main forms of silica scale (colloidal/amorphous or silicate) are produced and deposited. All types of silica scale begin with formation of colloidal silica particles in solution, which may then polymerize and be deposited as colloidal or amorphous silica scale, or may combine with any metal ions present (such as magnesium or calcium) to form silicate scale deposits.

More specifically, the polymerization rate of silica scale is generally pH dependant, with a maximum rate at about 8.0 to 8.5. Group II metals, especially calcium, magnesium and iron, are almost always present with silica, and these metal ions also affect the rate of silica scale development. Furthermore, in aqueous systems having pH higher than about 9.5, silicate types of scale, such as highly insoluble magnesium silicate, are the predominant type of silica scales formed, with very little amorphous silica scale, SiO₂. Thus, silicate scale tends to form at higher temperatures and alkaline pH. At pH of about 7.5, amorphous silica scale, SiO₂, is the predominant type of silica scale formed and deposited, with very little silicate scale formed as pH drops below 7.0. Thus, even in the presence of metals such as calcium, magnesium and iron, at lower temperatures and pH, silicate scale is not likely to form, leaving amorphous silica scale as the predominant problem. In either case, the removal of silica scale once it is formed is very difficult and costly.

Inhibiting the formation and deposition of silica scale is generally accomplished by one or more techniques including inhibition, dispersion, solubilization, and particle size reduction, which reduce or prevent formation and deposition of silica scale. Control of amorphous silica scale, which tends to occur in neutral or mildly alkaline pH conditions, has been studied less than silicate scale inhibition and removal.

Several polyacrylate compounds are known to perform successfully as inhibitors in aqueous systems for inhibiting the formation and deposition of scales of various types. Polyacrylates are a class of polymers derived from the polymerization of one or more acrylate monomers such as acrylic acid, methacrylic acid, acrylonitrile, and derivatives thereof. Each acrylic monomer contains a vinyl group (—C═C—) which is highly reactive. Due to this high reactivity of the carbon double bond of the vinyl group, acrylate monomers polymerize readily to produce many kinds of polyacrylate polymers useful in a variety of plastics, adhesives and chemical binder applications, among others.

For example, U.S. Pat. No. 4,536,292 describes a class of acrylate polymers prepared from an unsaturated carboxylic acid, an unsaturated sulfonic acid, and an unsaturated quaternary ammonia compound, as being suitable dispersants for inhibiting multiple types of scale in aqueous systems. U.S. Pat. No. 4,510,059 discloses a method for reducing formation of silica deposits in an aqueous system by adding an effective amount of a polyampholyte, i.e., a polymer containing polymerized units derived from at least one carboxylic monomer and at least one cationic containing monomer. U.S. Pat. No. 5,658,465 describes a method for inhibiting silica and silicate scale in water systems by adding a polymer having an N,N-disubstituted amide functional group.

Additionally, International Patent Application Publication No. WO 2010005889 describes alkoxylated amines or poly(alkoxylate) amines as being effective for inhibition of silica and silicate scale in aqueous systems. These poly(alkoxylate) amine inhibitors have backbones based on either propylene oxide (PO), ethylene oxide (EO), or mixtures thereof, and may further contain pendant carboxylic acid groups derived from, for example, acrylic acid or maleic acid.

International Patent Application Publication No. WO 2011028662 also provides a method for inhibiting the deposition of silica and silicate scale by adding to an aqueous system a polymer comprising units derived from an alkoxylated vinyl ether and at least one monomer having a carbonyl, sulfonate or phosphate group.

Carboxylic multipolymers containing sulfonic groups (—SO₂OH), such as those commercially available from The Dow Chemical Company, of Midland, Mich., U.S.A. under the tradename ACUMER 5000, are well known inhibitors of magnesium silicate and dispersants of colloidal silica and magnesium silicate scale in aqueous systems. It is also known in the industry that carboxylate homo- and co-polymers without sulfonic groups (—SO₂OH), such as those commercially available under the tradenames ACUMER 1000 and ACUMER 4300, also from The Dow Chemical Company, are typically less effective at avoiding silica scale deposition.

In addition to dispersants, it is known to add other compounds to aqueous systems to control scale build-up by binding with and forming a complex with metal cations. Such binding and complex formation may generally be described as sequestering, but is also commonly referred to as “chelating.” Compounds capable of such sequestering interaction with metal ions are known as “chelating agents” and they render the metal cations unavailable for formation and deposition of scale.

Chelating compounds are well known and include, without limitation, amino acids and their derivatives, such as ethylenediaminetetraacetic acid (EDTA) and other polyalkylenepolyaminepolyacetic acids, including polyacids of the alkylol substituents of the polyamines. Other chelating compounds have active groups consisting of carbonyl groups, sulfonic acid groups, amine groups, phosphonic acid groups, and the like.

Blends or mixtures of polymeric dispersants and chelating agents have been found to effectively inhibit formation and deposition of magnesium-based scales in aqueous systems. For example, Japanese Patent No. JP200763687A describes a phosphorus-free inhibitor blend for inhibiting comprising a polymer and a chelating agent at a polymer:chelating agent ratio of from 95:5 to 60:40. Japanese Patent No. JP200763687A states that the polymer and chelating agent may be added to the aqueous system separately and independent of one another, or may be mixed with one another prior to addition to the aqueous system, in effective amounts of between 90 and 500 parts per million. The suitable polymers are defined in Japanese Patent No. JP200763687A as a polyacrylic homopolymer or an acrylic acid (AA)/2-acrylamide 2-methylpropanesulfonic acid (AMPS) copolymer, while the chelating agent is identified as the amine ethylenediaminetetraacetic acid (EDTA) and similarly complex polyacetic acid-containing amines. This technology is specifically focused on, and shown to successfully address, the problem of formation and deposition of magnesium scale in water boiler systems.

It has also been recognized that acrylic polymers having chelating functionality are useful for binding metal ions in various applications. For example, in the search for phosphate-free builders substitutes for laundry and automatic dishwashing detergents, amino carboxylate compounds have been found to be effective chelating agents for such aqueous systems. U.S. Pat. No. 3,331,773, teaches preparation of water soluble polymers having chelating functionality by grafting water soluble chelating monomers onto water soluble polymers having aliphatic polymeric backbones. Diethylenetriamine, ethylenediamine tetraacetic acid (EDTA), and other polyalkylene polyamine polyacetic acids are identified in U.S. Pat. No. 3,331,773 as examples of chelating monomers suitable for grafting onto water soluble polymers. The resulting acrylic polymers having chelating functionality are useful for inhibiting precipitation of alkali earth metal salts, such as those based on magnesium and calcium, in aqueous systems.

The present invention provides a method for controlling silica scale deposition of the colloidal or amorphous type in aqueous systems.

### SUMMARY OF THE INVENTION

The present invention provides a method for controlling colloidal/amorphous silica scale deposition in an aqueous system. The aqueous system may have a pH of from 7.0 to 9.0. The method comprises adding to the aqueous system an effective amount of a synergistic combination comprising: A) 10% to 90% by weight of at least one carboxylate polymer comprising units derived from one or more carboxylate monomers; and B) 90% to 10% by weight of at least one chelating agent. The weight percent is based on the total weight of said synergistic combination and the sum of the weight percents of components A) and B) equals 100%.

The carboxylate monomers from which the carboxylate polymer is derived may be selected from the group consisting of: (meth)acrylic acid, maleic acid, itaconic acid, and salts thereof. Furthermore, carboxylate polymer may comprises from 50% to 99% by weight of the carboxylate monomer, and 1% to 50% by weight of at least one other another monomer selected from the group consisting of sulfonic-free ethyleneically unsaturated monomers and their derivatives.

The chelating agent is selected from the group consisting of: methylamine, ethanolamine (2-aminoethanol), dimethylamine (DMA), methylethanolamine (MEA), trimethylamine (TEA), ethyleneamine, ethylenediamine (EDA), diethylenetriamine (DETA), aminoethylethanolamine (AEEA), ethylenediamine triacetic acid (ED3A), ethylenediamine tetraacetic acid (EDTA), ethylenediamine disuccinic acid (EDDS), iminodiaacetic acid (IDA), iminodisuccinic acid (IDS), nitrilotriacetic acid (NTA), glutamic acid diacetic acid (GLDA), methylglycinediacetic acid (MGDA), hydroxyethyliminodiacetate (HEIDA), hydroxyethyl ethylenediamine triacetic acid (HEDA), diethylene triamine pentaacetic acid (DTPA), tetrasodium ethylene diaminetetraacetic acid, and derivatives thereof, and combinations thereof.

In some embodiments, the polymer(s) and one chelating agent(s) are physically blended together. In other embodiments, the carboxylate polymer(s) may already comprise polymerized units derived from at least one chelating agent.

The effective amount of the synergistic combination to be added to the aqueous system is from 0.1 to 400 ppm.

### BRIEF DESCRIPTION OF THE DRAWINGS

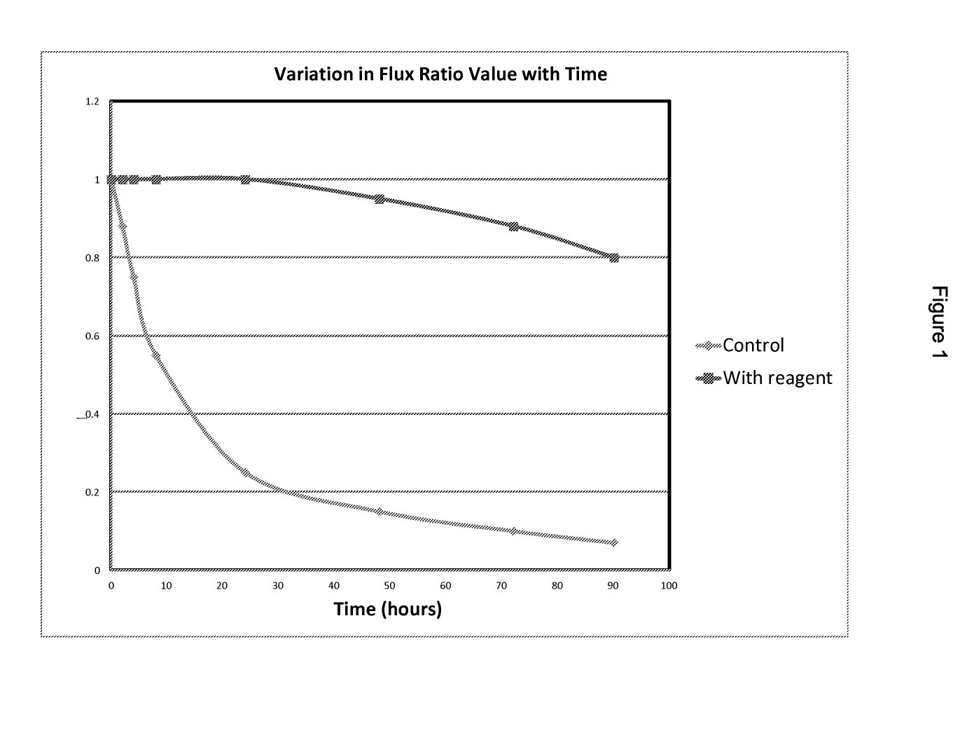

A more complete understanding of the present invention will be gained from the embodiments discussed hereinafter and with reference to the accompanying FIG. 1 which provides a graph showing the profile of flux ratio over time demonstrated during the control and Comparative Example 1 experiments described in the Examples.

### DETAILED DESCRIPTION OF THE INVENTION

All percentages stated herein are weight percentages (wt %), unless otherwise indicated.

Temperatures are in degrees Celsius (° C.), and “ambient temperature” means between 20° C. and 25° C., unless specified otherwise.

As used herein, the term “(meth)acrylic” includes acrylic acid and methacrylic acid.

“Ethylenically unsaturated monomers” means molecules having one or more double carbon-carbon bonds, which renders them polymerizable. Monoethylenically unsaturated monomers have one carbon-carbon double bond, while multi-ethylenically unsaturated monomers have two or more carbon-carbon double bonds. As used herein, ethylenically unsaturated monomers include, without limitation, carboxylic acids, esters of carboxylic acids, maleics, styrenes and sulfonic acids. Carboxylic acid monomers include, for example, acrylic acid, methacrylic acid, and mixtures thereof. Maleic monomers include, for example, maleic acid, maleic anhydride, and substituted versions thereof. Sulfonic acid monomers include, for example, 2-(meth)acrylamido-2-methylpropanesulfonic acid, 4-styrenesulfonic acid, vinyl sulfonic acid, 2-sulfoethyl(meth)acrylic acid, 2-sulfopropyl(meth)acrylic acid, 3-sulfopropyl(meth)acrylic acid, and 4-sulfobutyl(meth)acrylic acid. Further examples of ethylenically unsaturated monomers include, without limitation, itaconic acid, crotonic acid, vinyl acetic acid, acryloxypropionic acid, methyl acrylate, ethyl acrylate, butyl acrylate, methyl methacrylate, ethyl methacrylate, butyl methacrylate and isobutyl methacrylate; hydroxyalkyl esters of acrylic or methacrylic acids such as hydroxyethyl acrylate, hydroxypropyl acrylate, hydroxyethyl methacrylate, and hydroxypropyl methacrylate; acrylamide, methacrylamide, N-tertiary butyl acrylamide, N-methyl acrylamide, N,N-dimethyl acrylamide; acrylonitrile, methacryionitrile, allyl alcohol, allyl sulfonic acid, allyl phosphonic acid, vinylphosphonic acid, dimethylaminoethyl acrylate, dimethylaminoethyl methacrylate, phosphoethyl methacrylate, phosphonoethyl methacrylate (PEM), and sulfonoethyl methacrylate (SEM), N-vinyl pyrollidone, N-vinylformamide, N-vinylimidazole, ethylene glycol diacrylate, trimethylolpropane triacrylate, diallyl phthalate, vinyl acetate, styrene, 2-acrylamido-2-methyl propane sulfonic acid (AMPS) and its salts or combinations thereof.

“Polymer” means a polymeric compound or “resin” prepared by polymerizing monomers, whether of the same or different types. As used herein, the generic term “polymer” includes polymeric compounds made from one or more types of monomers. “Homopolymers,” as used herein means polymeric compounds which have been prepared from a single type of monomer. Similarly, “copolymers” are polymeric compounds prepared from two or more different types of monomers. For example, a polymer comprising polymerized units derived only from acrylic acid monomer is a homopolymer, while a polymer comprising polymerized units derived from methacrylic acid and butyl acrylate is a copolymer.

The term “polymerized units derived from” as used herein refers to polymer molecules that are synthesized according to polymerization techniques wherein a product polymer contains “polymerized units derived from” the constituent monomers which are the starting materials for the polymerization reactions. The proportions of constituent monomers, based on the total of all constituent monomers that are used as starting materials for a polymerization reaction are assumed to result in a polymer product having the same proportions of units derived from those respective constituent monomers. For example, where 80%, by weight, of acrylic acid monomer and 20%, by weight, of methacrylic acid monomer are provided to a polymerization reaction, the resulting polymer product will comprise 80% by weight of units derived from acrylic acid and 20% by weight of units derived from methacrylic acid. This is often written in abbreviated form as 80% AA/20% MAA. Similarly, for example, where a particular polymer is said to comprise units derived from 50% by weight acrylic acid, 40% by weight methacrylic acid, and 10% by weight itaconic acid (i.e., 50% AA/40% MAA/10% IA), then the proportions of the constituent monomers provided to the polymerization reaction can be assumed to have been 50% acrylic acid, 40% methacrylic acid and 10% itaconic acid, by weight, based on the total weight of all three constituent monomers.

The term “carboxylate monomers” is used hereinafter to mean polymerizable monomers containing a —COOH or —CO₂⁻ group. For example, without limitation, carboxylate monomers include: acrylic acid, methacrylic acid, maleic acid, itaconic acid, crotonic acid, and their salts.

As used herein, the term “carboxylate polymer” means a polymer comprising units derived from at least one carboxylate monomer.

The term “sulfonic-free,” as used herein to describe carboxylate monomers and copolymers, means that the carboxylate monomers or copolymers are essentially free of any sulfonic groups (—SO₂OH or —SO₂O⁻). More particularly, a carboxylate monomer or copolymer having less than 5% by weight sulfonic groups, based on the total weight of the polymer, is a “sulfonic-free” carboxylate monomer or copolymer suitable for use in the method of the present invention.

As used herein, the phrase “aqueous system” means any system containing water including, but not limited to, cooling water, boiler water, desalination, gas scrubbers, blast furnaces, sewage sludge thermal conditioning equipment, filtration, reverse osmosis, sugar evaporators, paper processing, mining circuits, and the like.

The term “silica scale” means solid materials containing silica that are deposited and accumulated on internal surfaces of water treatment equipment. “Silica scale” generally includes multiple types of silica scale such as colloidal or amorphous silica (SiO₂) and silicate (such as magnesium silicate). The accumulated silica scale may be, and sometimes is, a combination of silica and silicate types of scale, often where one or the other type of scale predominates. “Colloidal/amorphous silica scale” is the term used hereinafter to describe silica scale deposits that are predominantly of the colloidal/amorphous silicate type. Other kinds of scale besides the silica types may be present, such as calcium carbonate, calcium sulfate, calcium phosphate, calcium phosphonate, calcium oxalate, barium sulfate, silica, alluvial deposits, metal oxide, and metal hydroxide, depending upon what kinds of metals and other ions are present in the aqueous system.

The chemical reaction mechanism for formation of colloidal/amorphous silica scale involves condensation polymerization of silicic acid to polysilicates, catalyzed by hydroxide ions. This reaction mechanism proceeds generally as follows:

Si(OH)₄+OH⁻→(OH)₃SiO⁻+H₂O

Si(OH)₃⁻+Si(OH)₄+OH⁻→(OH)₃Si—O—Si(OH)₃ (dimer)+OH⁻

(OH)₃Si—O—Si(OH)₃ (dimer)→Cyclic→Colloidal→Amorphous Silica (scale)

Since the reaction mechanism is catalyzed by hydroxide ions, it proceeds slowly at low pH, but increases significantly above pH of about 7. Thus, prevention of silica scale formation in aqueous systems having “neutral” pH, such as, between 7.0 and 8.5, is of particular concern.

Interruption of the aforesaid mechanisms to control silica scale may be accomplished by one or more chemical actions including inhibition, dispersion, solubilization, and particle size reduction. Inhibiting the formation and deposition of silica scale, in general, means interruption of the above described silica scale formation mechanism at the point at which silica compounds are formed in solution but before precipitation or deposition. Interruption of the above described formation mechanism at the point at which one or more silica compounds aggregate and precipitate out of solution, thereby, preventing deposition of the silica scale, is referred to as dispersion.

Sequestration is the action of forming a chelate or other stable compound with an ion, atom, or molecule so that its no longer available for reactions with other compounds or molecules. Dispersion occurs when compounds which would otherwise aggregate, precipitate, or both, are kept dispersed in solution so that they do not precipitate or interact freely with one another.

The method of the present invention is suitable for controlling deposition of colloidal/amorphous silica scale in aqueous systems having neutral pH. The method comprises adding to the aqueous system an effective amount of a synergistic combination which comprises: (A) at least one sulfonate-free carboxylate polymer; and (B) at least one chelating agent. The sum of the weight percents of components A) and B) of the synergistic combination equals 100%.

In some embodiments, the aqueous system may have a pH between 7.0 and 9.5, such as for example, between 7.0 and 9.0, or between 7.0 and 8.0, or even between 7.0 and 8.5. In other embodiments, the aqueous system may have a pH between 7.5 and 9.0, or between 8.0 and 9.0, or even between 7.5 and 8.5.

In general, carboxylate polymers are polymeric compounds having polymerized units derived from at least one carboxylate monomer, or salt or other derivative thereof. Some carboxylate polymers are known to perform well as dispersants for inhibiting formation and deposition of various types of scale, including magnesium and calcium based scales. However, it is also known that carboxylate homopolymers, such as polyacrylic acid, and carboxylate copolymers, such as acrylic acid/maleic acid polymers, which do not include sulfonic functionality, are less effective inhibitors for silica scales. The carboxylate monomers suitable for use in the method of the present invention are free of sulfonic groups and will be discussed in further detail hereinafter.

The chelating agents suitable for inclusion in the synergistic combination used in accordance with the method of the present invention include acyclic amines, acrylic imines, and acrylic amides, including primary, secondary and tertiary forms thereof, as well as derivatives thereof. Suitable amines include, for example, without limitation, methylamine, ethanolamine (2-aminoethanol), dimethylamine (DMA), methylethanolamine (MEA), trimethylamine (TEA), ethyleneamine, ethylenediamine (EDA), diethylenetriamine (DETA), aminoethylethanolamine (AEEA), ethylenediamine triacetic acid (ED3A), ethylenediamine tetraacetic acid (EDTA), ethylenediamine disuccinic acid (EDDS). Suitable imines include, for example without limitation, iminodiaacetic acid (IDA), and iminodisuccinic acid (IDS). Other suitable chelating agents include, without limitation, nitrilotriacetic acid (NTA), glutamic acid diacetic acid (GLDA), methylglycinediacetic acid (MGDA), hydroxyethyliminodiacetate (HEIDA), hydroxyethyl ethylenediamine triacetic acid (HEDA), and diethylene triamine pentaacetic acid (DTPA), tetrasodium ethylene diaminetetraacetic acid among others.

In some embodiments, the synergistic combination used in the method of the present invention comprises from 90% to 10% by weight of at least one carboxylate polymer and from 10% to 90% by weight of at least one chelating agent, based on the total weight of the synergistic combination. Where the synergistic combination comprises two or more carboxylate polymers, the total amount of said polymers present is from 90% to 10% by weight, based on the total weight of the synergistic combination. Similarly, where the synergistic combination comprises two or more chelating agents, the total amount of said chelating agents present is from 10% to 90% by weight, based on the total weight of the synergistic combination

For example, the synergistic combination may comprise at least 30%, or at least 40%, or at least 60%, or even at least 75%, by weight, in total, of the at least one carboxylate polymer. Furthermore, the synergistic combination may comprise up to 80%, or up to 60%, or up to 40%, or up to 30% or even up to 20%, by weight, in total, of the at least one carboxylate polymer.

The synergistic combination may, for example, comprise at least 20%, or at least 40%, or at least 60%, or even at least 80%, by weight, in total, of the at least one chelating agent. Likewise, the at least one chelating agent may be present in the synergistic combination in an amount up to 80%, or up to 60%, or up to 40%, or even up to 20%, by weight, in total, based on the total weight of the synergistic combination.

As used herein, the term “effective amount” means that amount of the synergistic combination necessary to control deposition of colloidal/amorphous silica scale in the aqueous system being treated. In some embodiments, the effective amount of synergistic combination may be from 0.1 to 400 parts per million (ppm), based on the total weight of the aqueous system being treated. In other embodiments, for example, without limitation, the effective amount of synergistic combination may be at least 0.5 ppm, or at least 1.0 ppm, or at least 5.0 ppm, or at least 10 ppm, or at least 20 ppm, or at least 50 ppm, or even at least 100 ppm. In some embodiments, for example, without limitation, the effective amount of synergistic combination may be no more than 300 ppm, or no more than 200, or even no more than 150 ppm.

The manner of addition of the components of the synergistic combination, (A) at least one carboxylate polymer and (B) at least one chelating agent, is not particularly limited. For instance, the carboxylate polymer and the chelating agent may be added to the aqueous system to be treated separately and independently of one another, in the proportions described above. In other embodiments of the method of the present invention, the components of the synergistic combination, (A) the carboxylate polymer and (B) the chelating agent, are physically blended together, in the proportions described above, into a single combination before addition to the aqueous system to be treated. Furthermore, in some embodiments, the chelating agent is incorporated into the carboxylate polymer during polymerization of the monomer components of the carboxylate polymer, so that the carboxylate polymer of said synergistic combination comprises polymerized units derived from said chelating agent, as well as one or more carboxylate monomers.

As already mentioned hereinabove, the carboxylate polymers suitable for use in the method according to the present invention are either homopolymers of a carboxylate, or copolymers of at least one carboxylate monomer and, optionally, another monomer which is selected from the group consisting of sulfonic-free ethyleneically unsaturated monomers, their salts and derivatives thereof. Rather, it has been surprisingly discovered that the inclusion of the chelating agent with the carboxylate polymer successfully replaces the functionality of sulfonic groups, and the resulting combination behaves synergistically to control colloidal/amorphous silica scale in aqueous systems. Since, as discussed hereinabove, carboxylate polymers are known to be unsatisfactory at preventing silica scale deposition, the discovery that combining at least one carboxylate polymer and at least one chelating agent produces a synergistic combination which successfully controls colloidal/amorphous silica scale deposition in aqueous systems having neutral pH has been surprising and unexpected.

As understood by persons of ordinary skill in the relevant art, carboxylate monomers are a broad class of compounds which contain a carboxyl group (—COOH). Acrylate monomers also have a carboxyl group, —COOH, but also contain a readily polymerizable vinyl group (—C═C—). Removal of the hydrogen attached to the carboxyl group of (meth)acrylic acid, or a derivative thereof forms, a “carboxylate,” i.e., an anion of the formula RCO₂⁻ (where R is an organic group). The carboxylate anion, in turn, forms the corresponding carboxylate salt or carboxylate ester. Carboxylate salts have the general formula M(RCOO)ₙ, where M is a metal and n is 1, 2, 3 . . . , depending on the valence of the metal. Carboxylate esters, on the other hand, have the general formula RCOOR′, where R and R′ are organic groups and R′ is not hydrogen.

In particular, the carboxylate polymers suitable for use in the method of the present invention are sulfonic-free and comprise units derived from at least one of the following carboxylate monomers: (meth)acrylic acid, maleic acid, itaconic acid, and salts.

Furthermore, in some embodiments, the carboxylate polymer may comprise from 50% to 99% by weight of a carboxylate monomer, and 1% to 50% by weight of at least one other monomer comprising sulfonic-free ethyleneically unsaturated monomers, or their salts or derivatives thereof. Suitable derivatives of the other monomers include, without limitation, amides, imides, alkoxylates, quaternary ammoniums, pyrrolidones, oxazolines, formamide, acetamide, amines, phosphorous-based groups.

The method of polymerization employed to prepare carboxylate polymers useful in the method of the present invention for controlling deposition is not particularly limited and may be any method known, now or in the future, to persons of ordinary skill including, but not limited to, emulsion, solution, addition and free-radical polymerization techniques. This is true regardless of whether the at least one monomer constituents and chelating agent are all incorporated by polymerization reaction into the carboxylic polymer that comprises the synergistic combination used in the method of the present invention, or the at least one carboxylic monomer and, optionally, at least one other monomer are polymerized with one another and then physically mixed with the chelating agent to form the synergistic combination. It is further contemplated that the chelating agent may first be reacted with a carboxylate monomer or another monomer, followed by polymerization of the monomers with one another to produce the carboxylate polymer.

For example, in some embodiments, the carboxylate polymer may be prepared by performing free-radical polymerization reactions. Among such embodiments, some involve the use of one or more initiators. An initiator is a molecule or mixture of molecules that, under certain conditions, produces at least one free radical capable of initiating a free-radical polymerization reaction. Photoinitiators, thermal initiators, and “redox” initiators, among others, are suitable for use in connection with the present invention. Selection of particular initiators will depend on the particular monomers being polymerized with one another and is within the capability of persons of ordinary skill in the relevant art. Another category of suitable initiators is the group of persulfates, including, for example, sodium persulfate. In some embodiments one or more persulfate is used in the presence of one or more reducing agents, including, for example, metal ions (such as, for example, ferrous ion), sulfur-containing ions (such as, for example, S₂O₃(═), HSO₃(−), SO₃(═), S₂O₅(═), and mixtures thereof), and mixtures thereof.

Production of carboxylate polymers useful in the method of the present invention may also involve the use of a chain regulator. A chain regulator is a compound that acts to limit the length of a growing polymer chain. Some suitable chain regulators are, for example, sulfur compounds, such as mercaptoethanol, 2-ethylhexyl thioglycolate, thioglycolic acid, and dodecyl mercaptan. In some embodiments, the chain regulator includes sodium metabisulfite. Other suitable chain regulators include, for example without limitation, OH-containing compounds which are suitable for use in a mixture with water to form a solvent (such as isopropanol and propylene glycol).

Additionally, in some embodiments, the carboxylate polymer may be produced by aqueous emulsion polymerization techniques. Generally, aqueous emulsion polymerization involves monomer, initiator, and surfactant in the presence of water. The emulsion polymerization may be performed by a method that includes the steps of adding one or more monomers (which may be neat, in solution, in aqueous emulsion, or a combination thereof) to a vessel that contains, optionally with other ingredients, water.

Initiators suitable for use in emulsion polymerization processes include, for example, water soluble peroxides, such as sodium or ammonium persulfate; oxidants, such as persulfates or hydrogen peroxide, in the presence of reducing agents, such as sodium bisulfite or isoascorbic acid and/or polyvalent metal ions, to form an oxidation/reduction pair to generate free radicals at any of a wide variety of temperatures; water soluble azo initiators, including cationic azo initiators, such as 2,2′-azobis(2-methylpropionamide)dihydrochloride. Furthermore, the emulsion polymerization process may employ one or more oil-soluble initiators, including, for example, oil-soluble azo initiators.

One or more surfactants may also be employed during emulsion polymerization. For example, at least one of the surfactants may be selected from alkyl sulfates, alkylaryl sulfates, alkyl or aryl polyoxyethylene nonionic surfactants, and mixtures thereof.

The use, application and benefits of the present invention will be clarified by the following discussion and description of exemplary embodiments of the present invention.

### EXAMPLES

Various silica scale inhibitors were tested including existing commercial benchmarks, other copolymers and terpolymers with anionic, cationic and non-ionic groups. Furthermore, various blends were tested which contained homopolymer, copolymer and terpolymers; the details of which are as provided below.

The blends that are focus of the present invention are a combination of at least one carboxylic homopolymer or sulfonic-free copolymer together with at least one chelating agent. The details of which are as follows—

### Example 1

Combination 1 was a 50:50 combination of phosphinocarboxylic acid polymer, with weight average molecular weight of 4500 g/mol, and tetrasodium ethylene diaminetetraacetic acid.

### Example 2

Combination 2 was a 50:50 combination of a polymerization product of acrylic acid and maleic acid, terminated with phosphono end group and having weight average molecular weight of 2000 g/mol, and tetrasodium ethylene diaminetetraacetic acid.

Two other comparative blends were tested, which did not show synergistic performance, were as follows—

### Comparative Example 1

Blend 1 was a 50:50 combination of terpolymer made up of acrylic acid, t-butyl acrylamide and 2-acrylamido-2-methyl propane sulfonic acid having a weight average molecular weight of 4500 g/mol, and tetrasodium ethylene diamine tetra acetic acid.

### Comparative Example 2

Blend 2 described in below data is a 50:50 combination of terpolymer made up of acrylic acid, t-butyl acrylamide and 2-acrylamido-2-methyl propane sulfonic acid having a weight average molecular weight of 4500 g/mol and Pentasodium diethylenetriaminepentaacetate.

Furthermore, the performance existing commercial polymers (as detailed below) which are promoted by industry and known by persons of ordinary skill to provide good silica scale inhibition were tested to provide comparison benchmarks with the present invention.

### Comparative Example 3

Benchmark 1 is a polymerization product of acrylic acid, t-butyl acrylamide and 2-acrylamido-2-methyl propane sulfonic acid having a weight average molecular weight of 5000 g/mol.

### Comparative Example 4

Benchmark 2 is a polymerization product of acrylic acid, ethyl acrylate and 2-acrylamido-2-methyl propane sulfonic acid having a weight average molecular weight of 35000 g/mol.

### Comparative Example 5

Benchmark 3 is a polymerization product of maleic acid and diisobutylene having a weight average molecular weight of 15000 g/mol.

Other co- and ter-polymers were tested for performance along with of synergistic blends are combination of anionic, cationic and non-ionic groups. The details of which are as follows—

### Comparative Example 6

Polymer 1 was a polymerization product of acrylic acid and 2-acrylamido-2-methyl propane sulfonic acid having a weight average molecular weight of 11000 g/mol.

### Comparative Example 7

Polymer 2 was a polymerization product of acrylic acid, t-butyl acrylamide and 2-acrylamido-2-methyl propane sulfonic acid having a weight average molecular weight of 4500 g/mol.

### Comparative Example 8

Polymer 3 was a polymerization product of acrylic acid, diallyl dimethyl ammonium chloride and 2-acrylamido-2-methyl propane sulfonic acid having a weight average molecular weight of 15000 g/mol.

### Comparative Example 9

Polymer 4 was a polymerization product of acrylic acid and diallyl dimethyl ammonium chloride having a weight average molecular weight of 13400 g/mol.

### Comparative Example 10

Polymer 5 was a polymerization product of acrylic acid and Dimethylaminopropyl methacrylamide having a weight average molecular weight of 10800 g/mol.

### Comparative Example 11

Polymer 6 was a polymerization product of acrylic acid, polyethylene glycol methyl acrylate and 2-acrylamido-2-methyl propane sulfonic acid having a weight average molecular weight of 20900 g/mol.

### Comparative Example 11

Polymer 7 was a polymer synthesized from acrylic acid, 2-acrylamido-2-methyl propane sulfonic acid and vinyl group containing chelant moiety ethylene diamine triacetic acid, having a weight average molecular weight of 5200 g/mol.

Combinations 1 and 2, Blends 1-2, Benchmarks 1-3 and Polymers 1-7 were evaluated to determine performance properties including inhibition and/or dispersion of silica and/or silicate compounds from an aqueous component that includes water, dissolved source of silica (e.g. sodium silicate), calcium ion (Ca²⁺), magnesium ion (Mg²⁺), and bicarbonate ions (HCO₃⁻) at pH of 8 and at temperature of 20° C. An ability of the reagent to inhibit/disperse the precipitation of silica/silicate compounds from the aqueous component is measured through a membrane test to determine an amount of flux flowing through the membrane as a function of initial flux. To perform the test, an aqueous stock solution (brine) is prepared containing 200 mg/L SiO₂, 300 mg/L Ca as CaCO₃, 250 mg/L Mg as CaCO₃ and 150 mg/L HCO₃⁻ as CaCO3. The brine is optionally added with inhibitor reagent at a concentration of 50 mg/L active reagent amount (i.e., effective amount of 50 ppm).

A 10 L test aqueous component is prepared containing 50 ppm of reagent solution as per the conditions mentioned above. The test aqueous solution is adjusted to pH 8.0 which is maintained throughout the test. The test aqueous component is placed in water reservoir of the membrane test setup. The water reservoir contains a stirrer operated by a motor, a pH meter, a temperature probe and feed water outlet and recycle water inlets. The aqueous solution is maintained at 20° C. and pH 8 and continuously stirred to ensure uniformity of conditions.

The water is fed out of the water reservoir from feed water outlet via a piston pump under pressure of 0.7 MPa. The flow rate of this feed is maintained at 5 L/min as measured by flow meters. The water is fed into flat membrane cells that are made of SS316 and contain a flat sheet reverse osmosis membrane. The membrane can either be anionic, cationic or non-ionic or combination thereof in nature. The cell has one inlet from which the abovementioned feed water is input, and has two outlets one on either side of the membrane. The outlet that is on the same side of inlet (with respect to membrane partition) is called concentrate outlet, and the outlet that is on the other side of the inlet side is called permeate outlet. The water collected from permeate outlet side is recirculated back to water reservoir, and the water coming out of concentrate outlet side is fed to the next flat membrane cell. The subsequent flat membrane cells have similar arrangement as the first one described above. Three flat membrane cells are connected in series, one after the other, and the concentrate side outlet of the third and final setup is recirculated back to the water reservoir. The water flow collected (flux) from permeate side from these cells are measured by weighing them. This flux at any particular time is divided by the water flow collected from the same permeate side at time zero, and the ratio is represented by Fluxₜ₌ₜ/Fluxₜ₌₀. This quantity is used as a metric for comparison of performance of inhibitor/dispersant reagent. The higher is this ratio, the better is the performance of inhibitor/dispersant at inhibiting/dispersing silica/silicate scale.

The flux ratio is measured at time 2 hrs, 4 hrs, 8 hrs, 24 hrs, 48 hrs, 72 hrs and 90 hrs after initiating the test. The flux ratio at the start of the experiment is 1. As the experiment progresses, depending on how well the inhibitor/dispersant is working, the flux ratio will either remain at 1 or will start dropping. If the value remains at 1 then it means that the reagent is working well for silica/silicate precipitation prevention. If the reagent is not working, then it will be shown by reduction in flux ratio value. Once the flux ratio starts dropping, it will continue dropping and by nature do not increase again. Moreover, generally 90 hrs is considered a long enough time to note the performance of the reagent under these experimental conditions. Therefore for comparison of various reagents the flux ratio value at 90 hrs is used as reference point. A typical profile of flux ratio over time demonstrated during the experiments described herein is provided in FIG. 1. FIG. 1 shows the rapid decline of flux ratio over time for an aqueous system without any polymers or chelating agents added (i.e., “Control”), compared to the much more slight decline in a system treated with a synergistic combination in accordance with the present invention (i.e., Blend 1, Comparative Example 1). Since the concentration of all the reagents are maintained at a constant value, the comparison of change in flux ratio can be effectively used as the metric of effectiveness of reagent for inhibition/dispersion.

Chemical analysis of the membrane used in the experiments represented by Table 1 was performed by energy-dispersive X-ray spectroscopy (EDS), using a Thermo Noran NSS on Hitachi 3400 instrument, under accelerating voltage of 15 keV, a zero aperture and 5000-7000 counts per second to determine the chemical composition of the scale. This analysis of the membranes and silica scale deposited thereon indicated that the predominant type of scale formed on the membranes was colloidal/amorphous silica scale, rather than the silicate species, since the sample contained 25 wt % silica, but very little (0.5 wt %) magnesium.

TABLE 1

| | C | O | Mg | Al | Si | S | Cl | Ca | Ti |
|---|---|---|---|---|---|---|---|---|---|
| Control | 74 | 16 | | 0.1 | | 9.8 | 0.6 | | |
| Example 9 | 26 | 42 | 0.5 | 1.2 | 25 | 2.3 | 0.2 | 2.4 | 0.2 |

The comparative performance of the above-described combinations, benchmarks and polymers, under the aforesaid conditions, as measured using flux ratio is shown by the data in the following Table 2.

TABLE 2

| | | Flux(t = 90 hrs)/ |
|---|---|---|
| Example | Reagent | Flux (t = 0 hrs) |
| Control | None | 0.07 |
| Example 1 | Combination 1 | 0.83 |
| Example 2 | Combination 2 | 0.8 |
| Comp. Ex. 1 | Blend 3 | Blend incompatible, |
| | | no expt run |
| Comp. Ex. 2 | Blend 4 | 0.68 |
| Comp. Ex. 3 | Benchmark 1 | 0.8 |
| Comp. Ex. 4 | Benchmark 2 | 0.86 |
| Comp. Ex. 5 | Benchmark 3 | 0.87 |
| Comp. Ex. 6 | Polymer 1 | 0.5 |
| Comp. Ex. 7 | Polymer 2 | 0.55 |
| Comp. Ex. 8 | Polymer 3 | 0.45 |
| Comp. Ex. 9 | Polymer 4 | 0.1 |
| Comp. Ex. 10 | Polymer 5 | 0.18 |
| Comp. Ex. 11 | Polymer 6 | 0.8 |
| Comp. Ex. 12 | Polymer 7 | 0.8 |

As can be seen from Table 2, Combinations 1, 2 and 3 (Examples 1, 2 and 3) all demonstrate excellent colloidal/amorphous silica scale control, at levels similar to the commercial benchmark polymers (i.e., Comparative Examples 3, 4 and 5). In Comparative Example 1, Blend 1 showed incompatibility issues between the polymer and chelating agent, and could not be tested. Blend 2 of Comparative Example 2 showed inferior performance compared to the commercial benchmarks (i.e., Comparative Examples 3, 4 and 5). Other polymer reagents tested, without the presence of chelating agents or chelating functionality on the polymers, generally showed inferior performance compared to commercial benchmark, or merely performed the same.

What is claimed is:

1. A method for controlling colloidal/amorphous silica scale deposition in an aqueous system, said method comprising adding to the aqueous system an effective amount of a synergistic combination comprising:
A) 10% to 90% by weight of at least one carboxylate polymer comprising units derived from one or more carboxylate monomers; and
B) 90% to 10% by weight of at least one chelating agent,
wherein the weight percent is based on the total weight of said synergistic combination and the sum of the weight percents of components A) and B) equals 100%.

2. The method of claim 1, wherein said at least one polymer and said at least one chelating agent of said synergistic combination are physically blended together.

3. The method of claim 1, wherein said at least one carboxylate polymer of said synergistic combination comprises polymerized units derived from said at least one chelating agent.

4. The method of claim 1, wherein said one or more carboxylate monomers is selected from the group consisting of: (meth)acrylic acid, maleic acid, itaconic acid, and salts thereof.

5. The method of claim 1, wherein said at least one carboxylate polymer comprises from 50% to 99% by weight of a carboxylate monomer, and 1% to 50% by weight of at least one other another monomer selected from the group consisting of sulfonic-free ethyleneically unsaturated monomers and their derivatives.

6. The method of claim 1, wherein said at least one chelating agent is selected from the group consisting of: methylamine, ethanolamine (2-aminoethanol), dimethylamine (DMA), methylethanolamine (MEA), trimethylamine (TEA), ethyleneamine, ethylenediamine (EDA), diethylenetriamine (DETA), aminoethylethanolamine (AEEA), ethylenediamine triacetic acid (ED3A), ethylenediamine tetraacetic acid (EDTA), ethylenediamine disuccinic acid (EDDS), iminodiaacetic acid (IDA), iminodisuccinic acid (IDS), nitrilotriacetic acid (NTA), glutamic acid diacetic acid (GLDA), methylglycinediacetic acid (MGDA), hydroxyethyliminodiacetate (HEIDA), hydroxyethyl ethylenediamine triacetic acid (HEDA), diethylene triamine pentaacetic acid (DTPA), tetrasodium ethylene diaminetetraacetic acid, and derivatives thereof, and combinations thereof.

7. The method of claim 1, wherein said effective amount is from 0.1 to 100 ppm of said synergistic combination.

8. The method of claim 1, wherein said effective amount is from 1 to 50 ppm of said synergistic combination.

9. The method of claim 1, wherein the aqueous system has a pH of from 7.0 to 9.0.

10. The method of claim 1, wherein said carboxylate polymer comprises less than 5% by weight sulfonic groups, based on the total weight of said polymer.
